(19) United States
(12) Patent Application Publication
(10) Pub. No.: US 2026/0094184 A1
(43) Pub. Date: Apr. 2, 2026

(54) MULTI-GOAL CONTENT OBJECT DATA-PLACEMENT CONFIGURATIONS

(71) Applicant: STACKADAPT, INC., Toronto (CA)

(72) Inventors: Han Chen, Toronto (CA); Wanxuan Wang, Toronto (CA); Arif Zaman, Toronto (CA); Fatih Demirkale, Toronto (CA); Hongkai Yu, Toronto (CA); Nedialko Dimitrov, Toronto (CA); Sina Motevalli Bashi Naeini, Toronto (CA); Mohammad Hossein Sedighi Gilani, Toronto (CA)

(73) Assignee: STACKADAPT, INC., Toronto (CA)

(21) Appl. No.: 19/347,354

(22) Filed: Oct. 1, 2025

Related U.S. Application Data
(60) Provisional application No. 63/702,298, filed on Oct. 2, 2024.

(51) Int. Cl. G06Q 30/0251; G06Q 10/0639; G06Q 30/0242; G06Q 30/0273

(52) U.S. Cl. CPC G06Q 30/0251; G06Q 10/06393; G06Q 30/0246; G06Q 30/0275

(57) ABSTRACT

Systems and methods are described herein for select content for bid-processing and content placement online placement resources. A computer in an RTB bidding process transmits the selected content to an identified online resource that satisfies the various (and often competing) goal objective thresholds and budget thresholds. The computer transmits the content to the identified online resource, which forwards or transmits the campaign content for display at a user interface of an end-user. The computer analyzes historical data to evaluate the performance of content campaigns against multiple user-selected performance goals and priorities to determine whether to bid for content placement at a given online resource. The computer may generate a blocklist to reject placements at underperforming online resources. The computer may perform optimization functions to determine optimal bid prices that balance the goal objective thresholds and budget threshold and determine whether to bid for the placement.

### CROSS-REFERENCE TO RELATED APPLICATIONS

This application claims the benefit of and priority to US Provisional Application No. 63/702,298, entitled “Multi-Goal Campaign,” filed Oct. 2, 2024, which is incorporated by reference in its entirety.

### TECHNICAL FIELD

This application relates generally to systems and methods for developing online content for distribution to end-users at various online resources (e.g., websites, web-applications). More specifically, it relates to allowing content providers to efficiently develop the online content, evaluate key performance indicators (KPIs), and establish multiple goal objectives for dynamically determine future distribution and placement of the online content relative to the KPIs and goals.

### BACKGROUND

A content selection service (e.g., placement bidding service) may distribute and deliver content to online resources (e.g., websites, web-applications) on behalf of content creator (e.g., advertiser), in accordance with the creator's configurations of the content campaign. Prior art systems allow for connecting content from content campaigns with content distributors based on a set of keywords using keyword targeting. For example, a search engine may sell ads to appear when search requests contain specified keywords. A second method for placing content may include behavioral targeting. Under this method, a content generator can specify the retargeting of online advertisements to users that have been identified as having performed a conversion. Users with similar conversion characteristics (e.g., purchasing an item in the prior three months) may be grouped together. The users in the group may then be matched with a particular online content for delivery.

Another conventional approach involves evaluating a KPI or metric to determine where to place content. A problem with these conventional bidding services is the reliance on a single KPI, such as cost-per-click (CPC) or clickthrough rate (CTR), to determine where to place content. This singular focus can lead to ineffectual and/or inefficient placements that fail to balance other important campaign goals, such as engagement rates or conversion rates, among others.

Moreover, conventional content-placement bidding systems necessarily operate in high-speed and resource-intensive circumstances, where decisions must be made in milliseconds or faster. For instance, a technical problem inhibiting conventional content-placement bidding systems from implementing complex optimization with multiple KPIs are the significant computational and communication overhead operations associated with solving for many bid prices. Traditional systems face challenges when multiple objectives need to be taken into account, which significantly increases the complexity of the decision-making process and precludes real-time determinations by conventional approaches that consider only a single KPI. Competitions for online content placement is highly dynamic involving rapidly changing conditions, such as user behavior, bidstream quality, and competition. A traditional single-KPI bidding system may struggle to adapt to these rapid fluctuations, leading to ineffective or inefficient bidding and placement operations.

### SUMMARY

Aspects of the present disclosure relate to a method for multi-objective evaluation for computer-implemented data transmission within a distributed network environment. The method can include obtaining, by a computer, one or more configuration inputs indicating a total amount, a plurality of placement goal objectives, and one or more priority values corresponding to the one or more placement goal objectives. In some examples, the method can include obtaining, by the computer, historical targeting configuration data for a plurality of prior data transmissions. In examples, the method can include, for each prior data transmission, generating, by the computer, a set of goal performance metrics for the placement goal objectives based upon the historical targeting configuration data of the prior data transmission. In some examples, the method can include generating, by the computer, a blocklist including a set of one or more online resources having a goal objective value of a corresponding goal objective that fails to satisfy a threshold for the goal objective. In at least some examples, the method can include generating, by the computer, a placement instruction for placing content objects for at least one online resource in accordance with the blocklist.

In some aspects, the method can further include receiving, by the computer, user input specifying a minimum acceptable performance threshold for each placement goal objective. In aspects, the generating the blocklist can include analyzing, by the computer, historical performance data for each online resource to identify online resources that repeatedly fail to satisfy the threshold for at least one placement goal objective. In at least some aspects, the method can further include blocking, by the computer, at least one placement instruction for at least one content object associated with at least one online resource included in the blocklist.

In aspects, generating the placement instruction can include excluding, by the computer, any online resource included in the blocklist from eligibility for receiving content objects. In some aspects, the method can further include updating, by the computer, the blocklist in response to real-time performance data received during execution of the targeted placement. In at least some aspects, the set of goal performance metrics can include at least one of a cost-per-click, a click-through rate, an engagement rate, or a conversion rate. In aspects, the method can further include providing, by the computer, a user interface including the blocklist for display at a user device, the user interface configured to obtain an instruction for inclusion of an online resource in the blocklist.

In some aspects, obtaining the historical targeting configuration data can include retrieving, by the computer, impression-level data for each prior data transmission from one or more databases. In aspects, the method can further include transmitting, by the computer, the placement instruction to a placement engine configured to execute real-time targeting for data transmission.

Aspects of the present disclosure relate to a system. The system can include one or more processors. The one or more processors can be configured to obtain one or more configuration inputs indicating a total amount, a plurality of placement goal objectives, and one or more priority values corresponding to the one or more placement goal objectives. In some examples, the one or more processors can be configured to obtain historical targeting configuration data for a plurality of prior data transmissions. In examples, the one or more processors can be configured to, for each prior data transmission, generate a set of goal performance metrics for the placement goal objectives based upon the historical targeting configuration data of the prior data transmission. In some examples, the one or more processors can be configured to generate, by the computer, a blocklist including a set of one or more online resources having a goal objective value of a corresponding goal objective that fails to satisfy a threshold for the goal objective. In at least some examples, the one or more processors can be configured to generate a placement instruction for placing content objects for at least one online resource in accordance with the blocklist.

Aspects of the present disclosure relate to one or more non-transitory computer-readable mediums. The one or more non-transitory computer-readable mediums can have instructions stored thereon that, when executed by one or more processors, cause the one or more processors to perform operations. The operations can include obtaining one or more configuration inputs indicating a total amount, a plurality of placement goal objectives, and one or more priority values corresponding to the one or more placement goal objectives. In some examples, the operations can include obtaining, by the computer, historical targeting configuration data for a plurality of prior data transmissions. In examples, the operations can include, for each prior data transmission, generating, by the computer, a set of goal performance metrics for the placement goal objectives based upon the historical targeting configuration data of the prior data transmission. In some examples, the operations can include generating a blocklist including a set of one or more online resources having a goal objective value of a corresponding goal objective that fails to satisfy a threshold for the goal objective. In at least some examples, the operations can include and generating a placement instruction for placing content objects for at least one online resource in accordance with the blocklist.

Aspects of the present disclosure relate to a method for computer-implemented data transmission by optimizing on dual-variables in data transmission. The method can include obtaining, by a computer, one or more configuration inputs indicating a total value amount, one or more placement goal objectives, and one or more priority values corresponding to the one or more goal objectives. In aspects, the method can include obtaining, by the computer, a plurality of samples of a plurality of sample target requests based upon a set of placement target criteria. Each sample can include target request data of a sample target request for a sample online resource satisfying the target criteria. In some aspects, for each sample, the method can include generating, by the computer, a set of goal performance metrics for the plurality of placement goal objectives based upon historical targeting configuration data of prior content placement. In aspects, the method can include, for each sample, obtaining, by the computer, dual variables for an optimization function based upon the goal performance metrics corresponding to an optimal sample value for the sample online resource corresponding to the sample. In at least some aspects, the method can include generating, by the computer, an optimal target value for an incoming target request indicating an online resource using the dual variables of the optimization function.

In some aspects, the method can further include storing, by the computer, the dual variables in a non-transitory memory accessible to a placement engine for determining a next target value. In at least some aspects, obtaining the plurality of samples can include retrieving, by the computer, target request data from a real-time stream associated with a plurality of online resources. In some aspects, the method can further include updating, by the computer, the set of dual variables in response to one or more updates to one or more performance metrics received during execution of the targeted placement. In aspects, the set of goal performance metrics can include at least one of an expected click-through rate, an expected engagement rate, an expected conversion rate, or an expected cost-per-click.

In some aspects, the method can further include transmitting, by the computer, the optimal target value to a placement engine configured to submit the target request for the incoming target request. In aspects, the optimization function can include a non-linear programming model configured to optimize on the plurality of placement goal objectives according to the priority values. In at least some aspects, the method can further include generating, by the computer, a report indicating the optimal target values and corresponding dual variables for a plurality of online resources. In some aspects, obtaining the dual variables can include executing, by the computer, one or more machine-learning models, including at least one of a gradient-boosted tree, a support vector machine, or a neural network. In some aspects, the method can further include providing, by the computer, a user interface including the optimal target value for display at a user device, the user interface configured to obtain an adjustment input to at least one priority value for the placement goal objectives.

Aspects of the present disclosure relate to a system. The system can include one or more processors. The one or more processors can be configured to obtain one or more configuration inputs indicating a total value amount, one or more placement goal objectives, and one or more priority values corresponding to the one or more goal objectives. In aspects, the one or more processors can be configured to obtain a plurality of samples of a plurality of sample target requests based upon a set of placement target criteria. Each sample can include target request data of a sample target request for a sample online resource satisfying the target criteria. In some aspects, for each sample, the one or more processors can be configured to generate a set of goal performance metrics for the plurality of placement goal objectives based upon historical targeting configuration data of prior content placement. In aspects, the one or more processors can be configured to, for each sample, obtain dual variables for an optimization function based upon the goal performance metrics corresponding to an optimal sample value for the sample online resource corresponding to the sample. In at least some aspects, the one or more processors can be configured to generat an optimal target value for an incoming target request indicating an online resource using the dual variables of the optimization function.

Aspects of the present disclosure relate to one or more non-transitory computer-readable mediums. The one or more non-transitory computer-readable mediums can have instructions stored thereon that, when executed by one or more processors, cause the one or more processors to perform operations. The operations can include obtaining one or more configuration inputs indicating a total value amount, one or more placement goal objectives, and one or more priority values corresponding to the one or more goal objectives. In aspects, the operations can include obtaining a plurality of samples of a plurality of sample target requests based upon a set of placement target criteria. Each sample can include target request data of a sample target request for a sample online resource satisfying the target criteria. In some aspects, for each sample, the operations can include generating a set of goal performance metrics for the plurality of placement goal objectives based upon historical targeting configuration data of prior content placement. In aspects, the operations can include, for each sample, obtaining dual variables for an optimization function based upon the goal performance metrics corresponding to an optimal sample value for the sample online resource corresponding to the sample. In at least some aspects, the operations can include generating an optimal target value for an incoming target request indicating an online resource using the dual variables of the optimization function.

Embodiments described herein include systems and methods that may address the technical challenges mentioned above and may also provide any number of additional or alternative benefits. The embodiments relate to a system for configuring content campaign and real-time bidding (RTB) in online content placement, including software for multi-goal configurator functions. The system retrieves data from a historical database of past campaign impressions and evaluates the performance of these campaigns against predefined goals and respective priorities, in accordance with various campaign configurations selected or entered by a user, which may include an entity or person functioning as a content creator and/or content provider (e.g., advertiser). The system analyzes interactions between users and content, and balances various campaign objective values, such as cost-per-click (CPC), click-through rate (CTR), and engagement rates. Based on this analysis, the system generates a set of instructions for subsequent bidding operations, which the instructs the system on optimizing bid prices and placements in real-time while ensuring that multiple campaign objectives are met in accordance with the preconfigured comparable priorities. This approach enhances campaign efficiency and allows for more dynamic and responsive content placement.

Embodiments may include systems and methods for multi-goal configuration for computer-implemented bid processing. The systems and methods may include a computing device comprising at least one processor for performing operations or method comprising: obtaining, by a computer, one or more configuration inputs indicating a total budget amount, a plurality of placement goal objectives, and one or more priority values corresponding to the one or more placement goal objectives; obtaining, by the computer, historical campaign data for a plurality of prior content placements; for each prior content placement, generating, by the computer, a set of goal performance metrics for the placement goal objectives based upon the historical campaign data of the prior content placement; generating, by the computer, a blocklist including a set of one or more online resources having a goal objective value of a corresponding goal objective that fails to satisfy a threshold for the goal objective; and generating, by the computer, a bid placement instruction for placing campaign content for at least one online resource in accordance with the blocklist.

Embodiments may include systems and methods for computer-implemented bid-processing by optimizing on dual-variables in bid pricing. The systems and methods may include a computing device comprising at least one processor for performing operations or method comprising: obtaining, by a computer, one or more configuration inputs indicating a total budget amount, one or more placement goal objectives, and one or more priority values corresponding to the one or more goal objectives; obtaining, by the computer, a plurality of samples of a plurality of sample bid requests based upon a set of placement target criteria, each sample including bid request data of a sample bid request for a sample online resource satisfying the target criteria; for each sample, generating, by the computer, a set of goal performance metrics for the plurality of placement goal objectives based upon the historical campaign data of the prior content placement; for each sample, obtaining, by the computer, dual variables for an optimization function based upon the goal performance metrics corresponding to an optimal sample price for the sample online resource corresponding to the sample; generating, by the computer, an optimal bid price for an incoming bid request indicating an online resource using the dual variables of the optimization function.

### BRIEF DESCRIPTION OF THE DRAWINGS

Non-limiting embodiments of the present disclosure are described by way of example with reference to the accompanying figures, which are schematic and are not drawn to scale. Unless indicated as representing the background art, the figures represent aspects of the disclosure.

FIG. 1 depicts a block diagram of a distributed computer system for determination of audiences for content delivery.

FIG. 2 shows operations of a method for multi-goal configuration for computer-implemented bid processing.

FIG. 3 shows operations of a method for computer-implemented bid processing by optimizing on dual-variables in bid pricing for multiple placement goals.

FIGS. 4A and 4B show example instances of a multi-goal configurator user interface of a content configuration application.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein—and additional applications of the principles of the subject matter illustrated herein—that would occur to one skilled in the relevant art and having possession of this disclosure, are to be considered within the scope of the subject matter disclosed herein. Other embodiments can be used and/or other changes can be made without departing from the spirit or scope of the present disclosure. The illustrative embodiments described in the detailed description are not meant to be limiting of the subject matter presented.

The embodiments disclosed herein relate to a system for configuring content campaign and real-time bidding (RTB) in online content placement (sometimes referred to as data transmission or placement involving the delivery or insertion of digital content, such as advertisements or media, into a designated location within an online resource, webpage, or application for display to end-users, etc.), including software for multi-goal configurator functions (sometimes referred to as multi-objective evaluation). The system retrieves data from a historical database of past campaign impressions and evaluates the performance of these campaigns against predefined goals and respective priorities, in accordance with various campaign configurations selected or entered by a user, which may include an entity or person functioning as a content creator and/or content provider (e.g., advertiser). The system analyzes interactions between users and content, and balances various campaign objective values, such as cost-per-click (CPC), click-through rate (CTR), and engagement rates. Based on this analysis, the system generates a set of instructions for subsequent bidding operations, which the instructs the system on optimizing bid prices and placements in real-time while ensuring that multiple campaign objectives are met in accordance with the preconfigured comparable priorities. This approach enhances campaign efficiency and allows for more dynamic and responsive content placement.

Further, some embodiments may include functions and features that further allow the users (e.g., content creators) to define campaign targeting criteria, such as geography and audience demographics, through the user interface of the campaign configurator. A backend bidding component of the system continuously collects samples of incoming bid requests that match these targeting criteria. For each sample, the system records key data points, including the bid floor, the sample's weight in the overall population, and performance scores across multiple KPIs, such as expected CTR, whether the sample originates from a premium domain, and the likelihood of engagement or conversion. Using these collected samples and the advertiser's campaign objectives (e.g., percentage of premium domains or specific CPC goals), the system computes optimal bid prices by mapping bid prices to expected win probabilities, leveraging historical win/loss data modeled through non-linear functions or machine learning algorithms, such as CatBoost or XGBoost. This process forms the basis of a non-linear optimization problem, where bid prices are the primary decision variables, and campaign objectives are represented in either the objective function or as constraints. The system outputs a set of dual variables, significantly reducing the communication cost by simplifying the decision-making process. These dual variable values are then sent to the online bidding system, enabling real-time bid price computation for incoming bid requests based on real-time goals (e.g., KPIs or similar metrics).

The machine-learning models used for determining goal performance metrics or for optimization may include, but are not limited to, gradient-boosted trees (e.g., CatBoost, XGBoost), support vector machines, or neural networks, among other machine-learning algorithms. These models may be employed individually or in combination to analyze historical campaign data, predict performance metrics, and optimize bid prices or target values in accordance with campaign objectives.

A problem with conventional content placement and bidding services is reliance on a single KPI, such as CPC or CTR, to determine where to place content. This singular focus can lead to ineffectual and/or inefficient placements that fail to balance other important campaign goals, such as engagement rates or conversion rates, among others. By allowing content creators to define multiple goals, embodiments disclosed herein address these problems of inefficient online content placement by enabling the system to consider a wider range of performance goal objective values or metrics in real time. In this way, embodiments perform functions and operations for more holistic optimization of content placement compared to conventional approaches, providing better alignment with the advertiser's objectives.

When content creators attempt to manage campaigns according to multiple goals using conventional RTB systems, the conventional RTB systems suffer difficulty in effectively managing and allocating a preconfigured budget across different objectives and potential placement domains. For example, optimizing for both CPC and engagement rate might lead to over-spending in one area while neglecting another. Embodiments disclosed herein address these problems by implementing software programming that executes machine-learning techniques and operations that formulate a non-linear optimization problem that considers multiple goals as constraints or objectives within the system. In this way, the system may optimize budget allocation across goal objective values or metrics for each of the user-selected goals, thereby improving the use of computing resources, reducing wasteful spending, and ensuring that the content creator's budget is used in the most effective manner possible.

Traditional systems face challenges when multiple objectives need to be considered, which significantly increases the complexity of the decision-making process and precludes real-time determinations by conventional approaches that consider only a single KPI. Competitions for online content placement is highly dynamic involving rapidly changing conditions, such as user behavior, bidstream quality, and competition. A traditional single-KPI bidding system may struggle to adapt to these rapid fluctuations, leading to ineffective or inefficient bidding and placement operations. Embodiments disclosed herein may incorporate multiple goals and leverage past win/loss data through machine learning models, such as gradient-boosted trees (e.g., CatBoost or XGBoost), support vector machines, or neural networks. The system may continuously learn from past performance metrics and dynamically adjust or optimize the bidding strategy. This real-time adaptability addresses problems of conventional static bidding systems that cannot respond quickly enough to changes in market conditions.

Moreover, conventional content-placement bidding systems necessarily operate in high-speed and resource-intensive circumstances, where decisions must be made in milliseconds or faster. For instance, a technical problem inhibiting conventional content-placement bidding systems from implementing complex optimization with multiple goals is the significant computational and communication overhead operations associated with solving for many bid prices. Embodiments disclosed herein address these problems by implementing software functions of a bid optimization engine capable of handling multiple goals simultaneously. The bid optimization operations incorporate advanced algorithms, such as machine learning models and optimization techniques, for efficiently computing bid prices and balancing conflicting goals within time and resource demands of RTB operations. For instance, embodiments address the problems of rapid fluctuations and resource demands by employing dual variables to represent the bid price decisions more compactly, thereby significantly reducing the number of variables that need to be communicated between different parts of the system. Moreover, this reduction in communication and computation overhead beneficially facilitates faster decision-making and more efficient system performance in placement competitions, even with the added complexity of multiple goal demands.

The embodiments described herein can select content for bid-placement at one or more types of online placement resources (sometimes referred to as online resources). The online resource includes a computing device or system, such as third-party servers or SSP, which may accept and display the online content. The online resource may include an address, identifier, or computing device hosting the online services of the online resource. Non-limiting examples of the online resource may include a website, web-based application (web app), impression, frame or placement identifier of a webpage, domain, impression, Uniform Resource Identifier (URI) or Uniform Resource Locator (URL), or Supply-Side Platform (SSP), among others. A placement server or other type of server in an RTB bidding process (sometimes referred to as a content exchange server or RTB server) may transmit the selected content to an identified online resource (e.g., website, domain, impression, SSP) that satisfies the various (and often competing) goal objective thresholds and budget thresholds. The placement server transmits the content to the identified online resource, which forwards or transmits the campaign content for display at a user interface of an end-user.

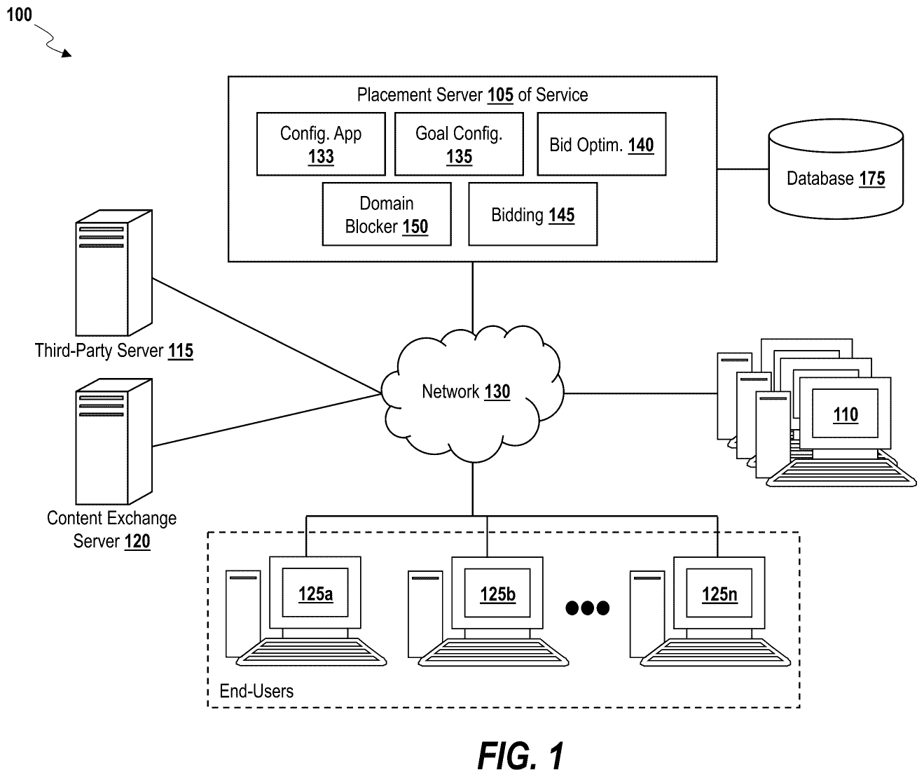

FIG. 1 depicts a block diagram of a distributed computer system 100 for determination of audiences for content delivery across a distributed network environment. The system 100 includes one or more placement servers 105 of a placement service, content provider devices 110 (sometimes herein referred to as client device) associated with a content provider preparing a content delivery campaign, third-party servers 115, content exchange servers 120 (sometimes referred to herein as real-time bidding (RTB) servers), and end-user devices 125a-125n (collectively referred to as end-user devices 125), among others, communicatively coupled with one another via one or more networks 130. The placement server 105 includes software programming defining or otherwise functioning as a configurator app 133, a goal configuration engine 135, a bid optimization engine 140, a bidding engine 145, and a domain blocker 150, among others. The placement server 105 includes or is in communication with a database 175. Each of the components in the system 100 may execute various software programming on one or more hardware processors coupled with memory to execute various operations. Certain components of the system 100 may be embodied in a single computing device or multiple computing devices.

The network(s) 130 includes any number of private or public networks for hosting and conducting electronic communications between electronic devices of the system 100. The network 130 may include telecommunications networks or data communications networks comprising hardware or software components for exchanging data between the devices of the system 100 in accordance with any number of networked communications.

The computing devices of the system 100 (e.g., servers, end-user devices 125, content provider devices 110) may include one or more computing devices and any type of computing device comprising hardware and software components configured to perform the various processes and tasks described herein, including one or more processors or software comprising machine-executable instructions executed by the one or more processors. Non-limiting examples of such computing devices of the system 100 include server computers, laptop computers, desktop computers, tablet computers, and smartphone mobile devices, among others. One or more computing devices of the system 100, such as a server computer (e.g., placement server 105), may execute webserver software for hosting one or more webpages according to web-related or data-communications protocols and computing languages.

The database 175 contains various types of data or information referenced by the placement server 105. The database 175 is hosted on any number of computing devices having software (e.g., database management software) and hardware (e.g., processors, non-transitory machine-readable storage medium) capable of performing the various processes and operations described herein. Non-limiting examples of the types of data contained in the database 175 includes campaign data (sometimes referred to as targeting configuration data involved in providing information associated with the configuration, execution, and performance of a content delivery campaign, such as targeting parameters, budget limits, goal objectives, and historical performance metrics, etc.), historical campaign data, configuration data, machine-learning models of a machine-learning architecture, website data, impression data, and user data, among other types of data.

The third-party servers 115 include computing devices that host websites or other online resources accessible to the end-user devices 125. The third-party servers 115 may be accessible according to certain addresses or identifiers, such as domains, Internet Protocol (IP) addresses, Uniform Resource Locators (URLs), Uniform Resource Identifiers (URIs), and impression identifiers, among others. For instance, each website or webpage is an online document in a markup language (e.g., Hypertext Markup Language (HTML)) stored or hosted by webserver software and database of the third-party server 115 and displayed on the end-user devices 125.

A content exchange server 120 may manage competitions among content provider devices 110 to compete for opportunities to deliver content on various webpages, such as the webpage accessed by the end-user device 125. The content exchange server 120 may be any third-party external web-service that publishes information (e.g., API service) and instructions (e.g., API requests) for executing various tasks described herein. Using the content selection values of the content provider devices 110, the content exchange server 120 may run a content selection process (e.g., a real time bid auction) to select one of the content provider devices 110 or a placement server 105. For example, the content exchange server 120 may select the content provider device 110 with the highest content selection value. The content exchange server 120 may send an indication of a provider selection to the selected content provider device 110, and the content provider device 110 may, in turn, transmit the content for placement as an element of the webpage accessed by the end-user device 125.

A content provider device 110 may communicate and interface with the placement server 105 to define a new content delivery campaign or update a previously defined delivery campaign, including defining characteristics of target audience of end-users targeted for the content delivery campaign, topics or terms for target websites, or characteristics of target websites or other online resources for placing content. The content provider device 110 may detect, identify, or otherwise receive a set of configuration inputs from a user interface of the content provider device 110 to define the user's content delivery campaign. In some implementations, using the content provider device 110, the user accesses campaign configuration webpage or configurator app 133 hosted by the placement server 105. The configurator app 133 may, for example, allow the user to enter the user configuration inputs that configure and define the user's content delivery campaign. The configurator app 133 may provide the various configuration inputs to the goal configuration engine 135 or other component of the system 100.

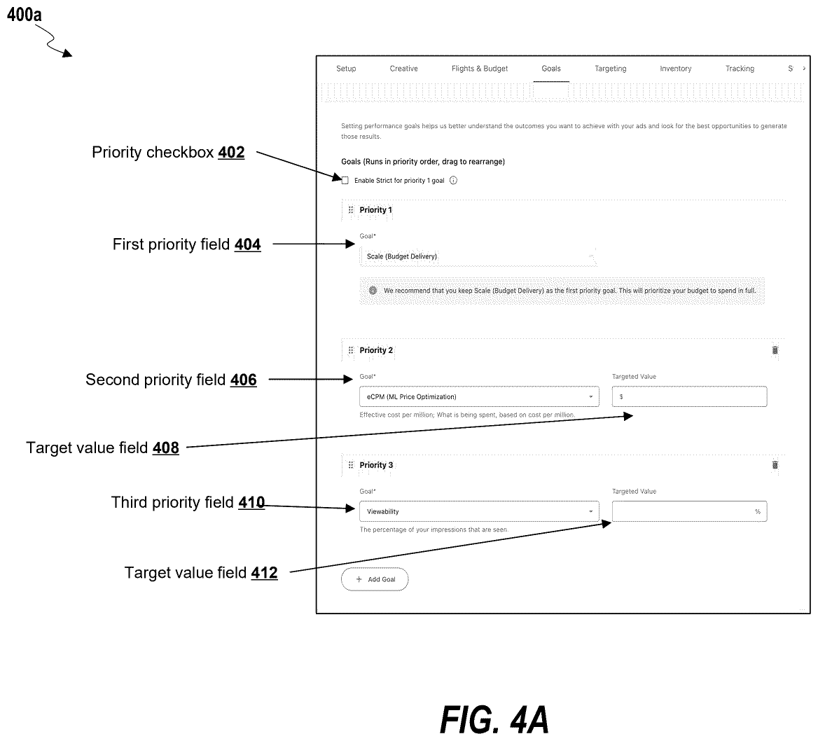

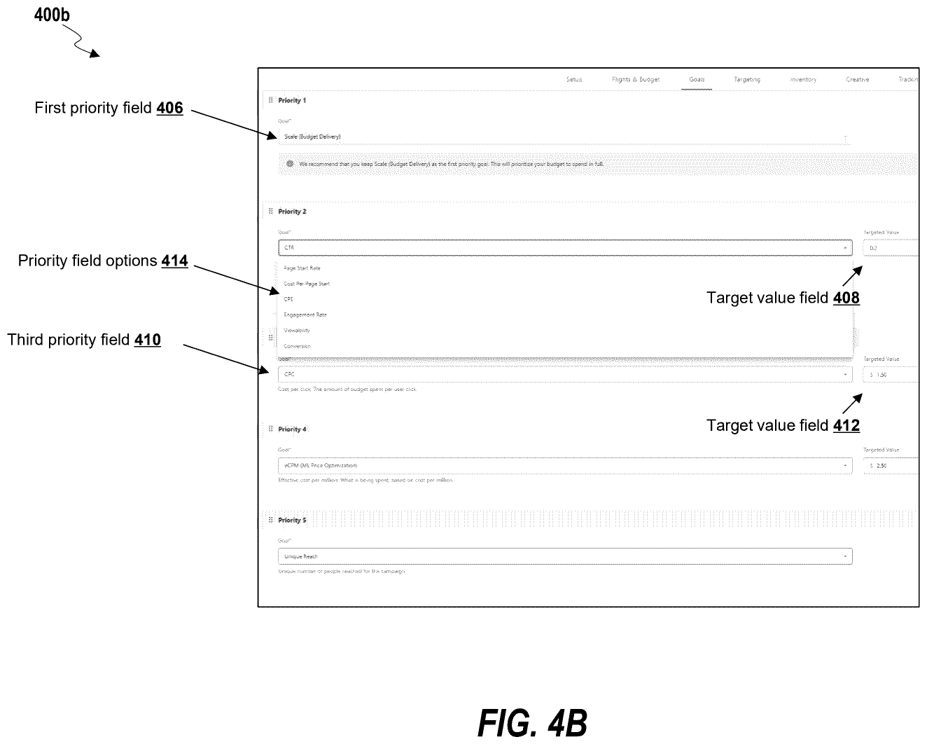

FIG. 4A and FIG. 4B show example instances of a multi-goal configurator user interface 400a-400b (generally referred to as a configurator user interface 400) of the configurator app 133. In the configurator app 133, the configurator user interface 400 includes various tabs, such as general setup tab for general settings, a creative tab for the content creator develop content, a budget tab for the content creator to manage content placement budgeting, a goals tab to select or enter to the placement goal objectives, relative priorities, and preconfigured target thresholds values, and targeting configurations, among others.

Turning back to FIG. 1, the end-user devices 125 include any computing devices operated by end-users to access online resources, such as websites or web-apps, and interact with online content. An end-user device 125 may include any type of computing device comprising hardware and software capable of performing various processes and operations described herein, such as accessing websites and rendering interactive content elements in user interface components of the end-user device 125. Non-limiting examples of the end-user device 125 include personal computers (e.g., laptops, desktops), server computers, tablets, smartphones, and edge devices or Internet-of-Things (IoT) devices, among other types of electronic processing devices.

When an end-user device 125 accesses a webpage (or other online resources) hosted on a third-party server 115, the webpage may include an element (e.g., an inline frame) in which to insert content (e.g., online advertisement) from an entity associated with the content provider device 110. Upon reading the element, the end-user device 125 may generate a request for a selection value for inserting content into the element of the webpage. The selection value may be used by a content exchange server 120 to select content (e.g., online advertisement) from the content provider device 110 or placement server 105 to place on the webpage accessed by the end-user device 125. The request may include an identifier for the end-user device 125, among other information. The identifier for the end-user device 125 may correspond to one of the identifiers in the definition of the audience. In some embodiments, the end-user device 125 may send the request to the content exchange server 120, and the content exchange server 120 in turn may forward the request to the placement server 105.

The placement server 105 includes software programming defining or otherwise functioning as various functional engines or modules. Certain components of the system 100 may be embodied in a single computing device or multiple computing devices. Non-limiting examples include the goal configuration engine 135, the bid optimization engine 140, the bidding engine 145, and the domain blocker 150, among others.

The placement server 105 includes software programming of the configurator app 133, which functions and serves as a frontend user-facing software application. The configurator app 133 generates, updates, and otherwise provides a configuration user interface that allows users to interact with a goal configuration engine 135, among other functions and features of the placement server 105. The user interface of the configurator app 133 allows the end-users to operate and interact with the various services of the system 100, which may include generating a user interface for an end-user device 125 and receiving various user inputs from the end-user device 125. A user of a content provider operates the content provider device 110 to access and interact with the configurator app 133. The user may operate and interact with the user interface of the configurator app 133 to provide various configuration inputs that, for example, describe the targeting criteria of the user's campaign. Non-limiting examples of the targeting criteria includes geography, content topics, and various types of audience characteristics, among other types of targeting criteria.

The goal configuration engine 135 executed by the placement server 105 obtains various user inputs as configuration inputs indicating campaign content goals and determines optimal content placement at one or more websites for bidding at domains of the websites. The goal configuration engine 135 may retrieve data from a database 175, which may contain past campaign impressions, and evaluate prior campaign performance. The goal configuration engine 135 may evaluate the prior campaign performance against the campaign goals and, optionally, goal priorities. The goal configuration engine 135 may, for example, generate a goal priority interaction matrix indicating the campaign goals and, optionally, corresponding goal priority values. According to the goal priority interaction matrix, the goal configuration engine 135 or domain blocker 150 (or another software component of the placement server 105) generates or references a list of instructions for downstream operations, such as bid-placement determinations.

The bid optimization engine 140 executed by the placement server 105 includes programming operations for optimizing a campaign's performance goal by, for example, evaluating bids or bid prices that the bid optimization engine 140 predicts, tests, or otherwise outputs. The bid optimization engine 140 takes various inputs from the goal configuration engine 135 or the end-user devices 125. Non-limiting examples of the inputs of the bid optimization engine 140 for optimization may include configuration setup instructions, campaign setup configurations, estimated amounts of arrivals, estimated bid floors, expected win probability, and campaign historical information, among others.

The configuration setup instructions provide operational instructions or executable parameters for the bid optimization engine 140 to execute or reference when optimizing the campaign goals or when the placement server 105 executes other functions. The goal configuration engine 135 may generate the configuration instructions according to various user inputs or other programming of the placement server 105. The bid optimization engine 140 then receives the configuration instructions from the goal configuration engine 135.

The campaign setup configurations provide various types of data or parameters for executing the bid optimization engine 140 or other components of the placement server 105. Certain setup configurations may be received as user configuration inputs entered via a configuration user interface, or certain setup configurations may be generated by the placement server 105 according to the user inputs. Non-limiting examples of the setup configurations may include performance goals, budget total, and bid amounts, among others.

The estimated amounts of arrivals may represent or correspond to a volume of requests that match campaign targeting criteria by inventory group bins. For the estimated amounts of arrivals, the bid optimization engine 140 or other component of the placement server 105 generates the estimated amounts of arrivals using a machine-learning model of a machine-learning architecture that learns from historical patterns in amounts of arrivals. Inventory group bins are cluster labels generated by inventory group models. The placement server 105 assigns data traffic with similar performance common inventory group bins.

The bid optimization engine 140 or other component of the placement server 105 may compute or reference from the database 175 one or more estimated bid floors, representing a likely floor or minimal bid amount. The placement server 105 computes the bid floor for a given domain or placement identifier based on, for example, prior data associated with the given domain, placement identifier, or historic perform of a campaign.

The bid optimization engine 140 or other component of the placement server 105 may compute or reference from the database 175 an expected win probability. For instance, the placement server 105 executes a function that maps bid prices for sample bid request or prior bid request data, to an expected win probability on the bid request. The placement server 105 executes this function to estimate the win probably based upon, for example, past win/loss data that may be stored in the database 175, and, in some cases, may include one or more gamma distributions.

As mentioned, the bid optimization engine 140 may reference and implement various types of historical campaign data in the database 175. Non-limiting examples of the historical campaign data may goal performance, win probability, and bid pacing, among other types of data.

The bid optimization engine 140 is programmed and trained for balancing bid-pricing for potential placements against the user's configured goals as parameter constraints. The bid optimization engine 140 queries or otherwise searches prior bid prices of prior bid data in the database 175 and/or the bid prices in a current or recent bid stream to identify a combination of one or more bids that could potentially expend the user's configured full budget. For instance, the bid optimization engine 140 searches for and identifies a set of bid prices for potential bid placements that would spend the predetermined total budget. The bid optimization engine 140 may further identify the set of bid prices for potential bid placements that satisfy each campaign performance goals as constraints and maximize an objective function. The bid optimization engine 140 then generates the set of bid prices for each inventory group bin, which the backend domain blocker 150 uses to respond to bid requests for a bid stream.

In some implementations, the bid optimization engine 140 (or bidding engine 145 or other component) of the placement server 105 collects and stores, into the database 175 samples of incoming bid requests that match the targeting criteria of the user's content campaign. These samples of incoming bid requests may include various types of data for prior historic bid requests associated with prior campaigns or for current inbound bid requests for current or future (e.g., under development or unlaunched) content campaigns. For example, for each sample bid request, the bidding engine 145 may record and store: a bid floor; a sample weight in overall population; and a sample bid request score (or each objective goal scores or values) for multiple goal objectives (e.g., a CTR expected on the sample for the particular placement; whether the sample comes from a premium domain; a likelihood of engagement or conversion from the sample).

As mentioned, the bid optimization engine 140 (or bidding engine 145 or other component) of the placement server 105 may generate, compute, or other determine bid prices, which may include performing functions such as an optimization function and dual-variable optimization. The bid optimization engine 140 determines the bid price based on various inputs, such as data of samples of bid requests captured or collected from the bid-stream, the campaign configurations (e.g., campaign goals), and expected probabilities of win. The bid optimization engine 140 may obtain the user's campaign configurations as inputs, such as the campaign's objectives (e.g., percentage of premium domains that need to be purchased; cost-per-click (CPC) objective value; CTR objective value; engagement rate objective value). For probabilities of win, the bid optimization engine 140 may execute or perform a win-probability function that maps bid prices for each sampled bid request against an expected win-probability on the bid request. The bid optimization engine 140 may execute and estimate the win-probability function based upon historic bid data, such as win data and loss data. The win-probability function of the bid optimization engine 140 may include a non-linear mixture of gammas, or a step-function determined by a gradient boosted tree algorithm (e.g., CatBoost, XGBoost), support vector machines, or neural networks.

Optionally, the bid optimization engine 140 determines the bid price using a non-linear optimization operation as an optional input. In executing the non-linear optimization, the bid optimization engine 140 formulates a non-linear optimization problem where: each objective is represented in the objective function of the problem or as a constraint in the problem; the primal decision variables are the bid prices for each sampled bid request; and the objective or constraints can compute quantities values (e.g., expected number of clicks, expected number of impressions, expected budget spent, expected CTR on the sampled bid requests), using the win-probability function that mapping bid prices against win probabilities provided as input. The output from the non-linear optimization problem includes a set of dual variables that can recover the set of decision of variables through solving an equation. The number of dual variables may be less than the number of primary decision variables, thereby reducing communication costs of the solution. In some cases, the non-linear optimization problem can be discretized into a discrete mixed-integer program function, by selecting various bid price cutoffs possible for each bid request. The mixed-integer program can be solved through Linear Programming (LP) relaxation or through various search algorithms that search for dual variable values. The bid optimization engine 140 or other component of the placement server 105 may then send the dual variable values to the bidding engine 145 as the online bidding system. The bidding engine 145 or the bid optimization engine 140 computes prices for incoming bid requests in an online fashion of a bid stream using the incoming bid request's real-time estimated objective goal values (e.g., values of KPIs).

In some embodiments, the placement server 105 is further configured to generate a report indicating the optimal target values and the corresponding dual variables for a plurality of online resources. The report may include, for each online resource, the computed optimal bid price or target value, the associated dual variable values used in the optimization process, and relevant performance metrics. This report can be provided to a user via a user interface or stored in a database 175 for subsequent review and analysis. The report enables users (e.g., campaign managers) or system administrators to review the optimization outcomes, audit the decision-making process, and adjust campaign parameters as needed. Moreover, this reduction in communication and computation overhead beneficially facilitates faster decision-making and more efficient system performance in placement competitions, even with the added complexity of multiple goal demands.

The bidding engine 145 executed by the placement server 105 or other software component of the system 100 may receive various types of instructions or configuration parameters for placing bid placements. In some cases, the bidding engine 145 receives, for example, an instruction for viewability optimization and/or an instruction for unique reach optimization. In response to receiving a viewability optimization instruction, the domain blocker 150 updates a viewability threshold with a specified value. The domain blocker 150 may reference and implement the viewability threshold to reject or otherwise block certain bid requests that are predicted to have low viewability scores that fail to satisfy the viewability threshold. The bidding engine 145 or other component of the placement server 105 may manage a unique reach metric according to a frequency cap threshold, which may be tuned or adjusted. When the bidding engine 145 receives an instruction for unique reach, the bidding engine 145 implements a frequency cap-based bid-rejections or bid-blocking. For example, the domain blocker 150 may reject or otherwise block bid requests from users already served more impressions than allowed by the preconfigured frequency cap threshold.

The domain blocker 150 generates, updates, and references a blocklist of domains and supply-side platforms (SSPs) that fail to satisfy preconfigured objective or goal thresholds values. The domain blocker 150 includes software programming executable by the placement server 105 or other computing device of the system 100. Non-limiting examples of such objective threshold values may include minimum clickthrough rate (CTR), maximum CTR, maximum cost per reach or result (CPR), minimum CPR, maximum cost per acquisition or action (CPA), and minimum CPA, among others. The domain blocker 150 references the database 175 and analyzes the historical performance data across the domains and the SSPs. When conducting the analysis for a domain or SSP, the domain blocker 150 executes one or more hypothesis tests to determine whether the domain or the SSP meets the preconfigured specific objective threshold values (e.g., min CTR, max CTR, min CPR, max CPR, min CPA, max CPA). The domain blocker 150 generates, as the output or result of the analysis result, includes a blocklist of particular domains and/or SSPs by campaign that fail to satisfy the objective thresholds. The domain blocker 150 may store the blocklist into the database 175 or any non-transitory machine-readable storage medium of the system 100 that is accessible to the placement server 105. The backend bidding engine 145 may query the domain blocker 150 or otherwise reference a data structure (e.g., computer file, data stream, database record(s) of the database 175) containing entries of the blocklist to determine whether to reject or otherwise block certain bid requests for certain domains or SSPs of the blocklist. If the bidding engine 145 determines or receives an indication from the domain blocker 150 that the blocklist contains a particular domain or SSP in a bid request, then the bidding engine 145 rejects or otherwise blocks the bid request for the domain or SSP.

In some embodiments, the placement server 105 or other component of the system 100 provides a user interface that displays the blocklist at a user device 125, 110. The user interface is configured to allow a user to review the current blocklist and to input an instruction for inclusion of one or more additional online resources in the blocklist. For example, the user may select or enter identifiers for online resources to be added to the blocklist, and the placement server 105 will update the blocklist accordingly. This interactive functionality enables administrator users (e.g., campaign managers) to manually adjust the blocklist in response to observed performance or strategic considerations. The domain blocker 150 references the database 175 and analyzes the historical performance data across the domains and the SSPs.

Optionally, a selection handler (not shown) includes software programming executing on the placement server 105 may retrieve, receive, or otherwise identify the request for the selection value from the end-user device 125. The request may be part of a part of a bid stream. The bid stream may be a data stream of published URLs available for bids to content generators interested in placing campaign content at those URLs. Upon receipt, the selection handler may parse the request for the selection value to extract or identify the identifier for the end-user device 125. With the identification, the selection handler may compare the identifier with the identifiers in the audience defined for the content delivery campaign of the content provider device 110.

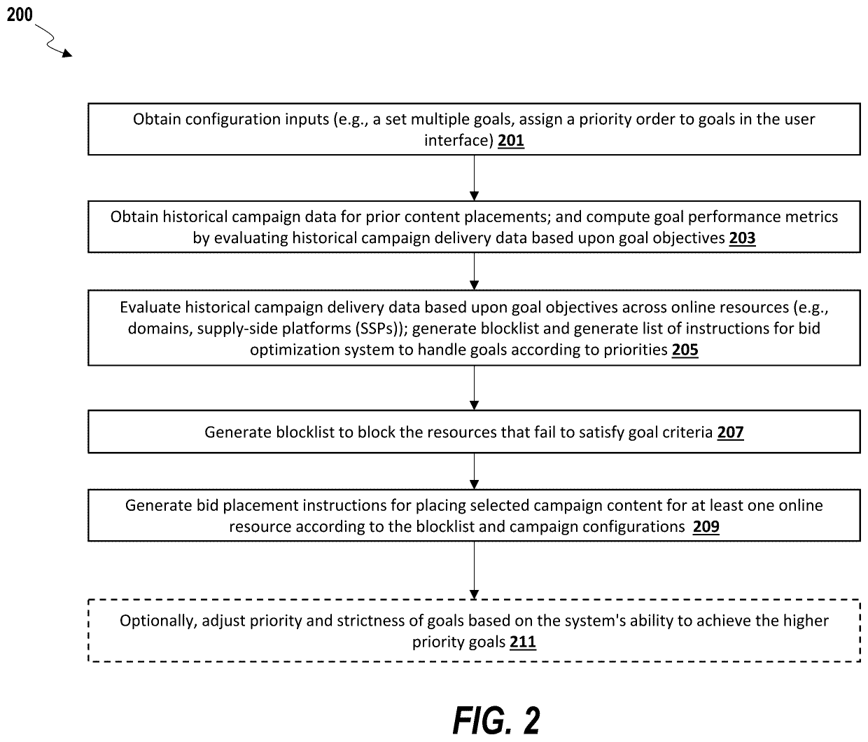

FIG. 2 shows operations of a method 200 for multi-goal configuration for computer-implemented bid processing. The multi-goal configuration allows a content-creator users to operate configuration app to specify and optimize for multiple placement goals of a digital content campaign, rather than a single goal, which may set multiple placement goals and place or optimize according to goal priorities assigned or otherwise corresponding to the placement goals.

For ease of description, a server computer (e.g., placement server 105) performs various operations described for the method 200, though embodiments are not so limited. In other embodiments, the method 200 or certain aspects of the method 200 may be performed by any number of computing devices and/or by various types of computing devices. In some embodiments, for example, the method 200 may be performed by one or more components described with respect to the system 100 of FIG. 1.

In operation 201, the server obtains one or more configuration inputs from a content-creator user. The configuration inputs indicate, for example, a total budget amount, a plurality of placement goal objectives, and one or more priority values corresponding to the one or more placement goal objectives, among others. For instance, the user may enter and provide configurations that set multiple placement goals and assign a priority in the user interface of a configuration app.

The configuration inputs may further indicate targeting criteria for the user's content campaign. The targeting criteria for online placement resources, such as domains, websites, SSPs, impressions, or the like

In operation 203, the server obtains historical campaign data for a plurality of prior content placements. The server may, for example, obtains samples of prior or current bid requests that satisfy campaign targeting criteria in the configuration inputs of the content campaign. When a campaign is configured, the user configures the set of specific objective goals (e.g., CTR, CPC, viewability). The server or database captures and stores the historical data from previous campaigns and real-time bid requests, analyzing the goal performance of online resources (e.g., domains, SSPs, content frames) to evaluate performance relative to these objective goals.

In some embodiments, obtaining the historical targeting configuration data includes retrieving placement-level data (e.g., impression-level data) for each prior data placement or transmission from one or more databases. The placement-level data may comprise detailed records of individual content placements, including identifiers for the online resource, timestamps, bid amounts, performance metrics such as click-through rate, engagement rate, conversion rate, and other relevant attributes. By accessing and analyzing placement-level data, the server can more accurately evaluate the performance of prior placements and optimize future content placement decisions. When a campaign is configured, the user configures the set of specific objective goals (e.g., CTR, CPC, viewability). The server or database captures and stores the historical data from previous campaigns and real-time bid requests, analyzing the goal performance of online resources (e.g., domains, SSPs, content frames) to evaluate performance relative to these objective goals.

In operation 205, for each prior content placement instance for an online resource, the server generates a set of goal performance metrics for the placement goal objectives based upon the historical campaign data of the prior content placement. For instance, the server may evaluate the historical campaign delivery data to compute various performance metrics, such as CTR, CPC, and engagement rate, among others.

In operation 207, the server generates a blocklist comprising a set of one or more online resources having a goal objective value of a corresponding goal objective that fails to satisfy a threshold for the goal objective. The server may generate a list of instructions for a bid optimization engine and bidding placement engine according to the objective goals and corresponding priority values. The list of instructions may include the blocklist or instructions for generating the blocklist, and instructions for placing bids at certain online resources that satisfy the user's goal thresholds and goal priorities, among other types of placement target criteria. The server may use or reference the blocklist to analyze historical performance across online resources (e.g., domains, SSPs, frames) to block those online resources that fail to satisfy one or more goal thresholds.

As the campaign progresses, the server may perform various statistical tests on the performance data of each online resource (e.g., domain, SSP, content frame). If the server determines that certain online resources underperform relative to the set of goal objectives (e.g., low CTR, poor engagement), then the server may add them to a blocklist. The server adds online resources (e.g., domains, SSPs, content frames) that fail to satisfy the minimum performance goal thresholds for one or more goal objectives. For example, if a domain consistently delivers a lower CTR than required, the server will block that domain to prevent future bids from being placed on that domain.

In operation 209, the server generates a bid placement instruction (sometimes referred to as a placement instruction) for placing content objects (e.g., campaign content) for at least one online resource in accordance with the blocklist. When a new bid request arrives, the server may reference the blocklist to determine whether the online resource indicated in the bid request matches any entries on the blocklist. If the request originates from or for a blocked online resource (e.g., domain, SSP, frame), then the server automatically rejects or otherwise blocks the bid request and does not place a bid. If the request passes the blocklist check, then the server may proceed to evaluate the online resource associated with the bid request against other real-time performance goals, such as the predicted CTR, conversion likelihood, and whether the online resource involves a premium domain.

In some embodiments, generating the placement instruction comprises excluding, rejecting, or otherwise blocking any online resource included in the blocklist from eligibility for receiving content objects. When the server generates a placement instruction, the server references the blocklist to confirm that any online resource identified in the blocklist is not selected for content placement. This exclusion, rejection, or blocking process prevents campaign content from being delivered to underperforming or undesirable online resources, thereby improving overall campaign effectiveness and alignment with user-defined goals. When a new bid request arrives, the server may reference the blocklist to determine whether the online resource indicated in the bid request matches any entries on the blocklist. If the request originates from or for a blocked online resource (e.g., domain, SSP, frame), then the server automatically rejects or otherwise blocks the bid request and does not place a bid.

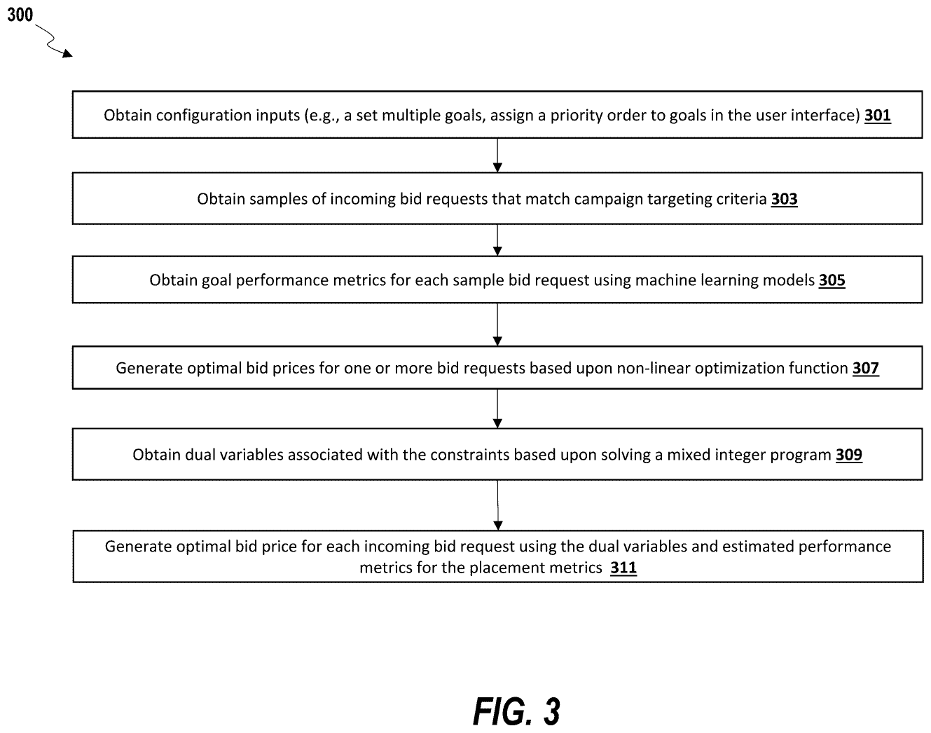

In some implementations, where the bid request passes the blocklist filter, the server may compute an optimal bid price (as in operation 311 of FIG. 3) using the real-time performance goals associated with the bid request. The server applies dual variables and optimization algorithms to determine the most cost-effective price, balancing the likelihood of winning the auction with the user's campaign goals (such as maximizing impressions while staying within the desired CPC).

The server submits the computed bid price into the bid-stream for auction, competing against other advertisers for the same impression. If the server wins the auction, based on the computed bid price and win probability, then server proceeds to serve the content. If the server loses the auction, then the server does not provide the content for placement and the system moves on to evaluate the next available bid request.

When the server successfully wins, the content is placed within the online resource specified by the bid request. The server may continue to track the performance of the content placement (e.g., tracking clicks, engagements, and conversions) and collect data for future operations or optimizations. For instance, if the content placement performs well (e.g., achieves the desired CTR or engagement rate), then the online resource remains active for future bids. If, however, the content placement performance is below target goal thresholds, then the server may reevaluate the online resource, potentially adding the online resource to the blocklist for future exclusions, rejections, or blocking.

Optionally, in operation 211, the server may adjust the objective goals, such as increasing or decreasing a goal's priority or a goal's strictness threshold, based upon the server's ability to achieve the higher priority goals. For instance, the server can dynamically adjust objective goals during a campaign to ensure that the server meets the user's higher-priority objectives while still attempt to satisfy secondary or other goals.

As mentioned, the server may handle multiple objectives, each with an assigned priority level. The user may configure, for example, primary and secondary content placement goals, such as placements for maximizing the CTR, minimizing the CPC, and placements likely offering a specific percentage of impressions on premium domains. The server may continuously monitor the performance of these goals using the bid request data and win-loss data.

If the server determines, for example, a high-priority goal (e.g., maximizing CTR) fails to satisfy a goal threshold constraint, then the server may relax (or reduce) lower-priority objectives (e.g., reducing CPC or engagement rate thresholds) to allocate more resources (e.g., budget) to placements satisfying the higher priority goals. Likewise, if the server determines, for example, the higher-priority goals are satisfying threshold goals at a threshold amount of consistency, then the system may tighten (or increase) lower-priority objective constraints, increasing the likelihood of satisfying each goal objective simultaneously.

In some embodiments, the server uses a goal priority interaction matrix to assess how objectives affect each other. This matrix helps the server understand the trade-offs between goals. For example, increasing the bid price to achieve a higher CTR might increase CPC. The system assesses these interactions and adjusts bid prices accordingly to balance these objectives, mitigating the effect that changes to one goal negatively impacts other goals. By continuously evaluating these interdependencies, the server may adjust the goals to maximize overall campaign performance.

In some implementations, the server monitors the campaign performs by continuing to capture and store the real-time campaign bid data from the ongoing bid-stream and/or continuing to generate updated KPI metrics (e.g., CTR, engagement rate, conversion likelihood), at given interval or in response to a trigger condition (e.g., bid request lost or won for a given placement or online resource). The server continues to reference this information as feedback, which the server references to dynamically adjust the user's campaign objective goals based on the current campaign performance. For example, if the server determines that the market conditions (e.g., competition, bid floors) changed or a certain KPI underperforms relative to a threshold amount of losses or rate of losses, then the server system may, for example, automatically adjust the weight or importance of certain goals or relax the objective goal threshold. For instance, if CTR or conversion rates are lower than expected CTR or conversion rates, then to improve performance in other areas without overspending, the server may, for example, increase the threshold amount or rate of placements at premium domains and/or lower bid floors. As another example, if the server determines that the server cannot satisfy a (potentially strict) CPC threshold without also significantly adjusting other goal thresholds, such as impressions or CTR, then the server may adjust the CPC objective threshold slightly upward or otherwise loosen the threshold to reduce the required impact that would otherwise be required. In this way, the server may balance the overall campaign goals.

In some embodiments, the server may dynamically adjust budget allocation between online resources or objective goals. For example, if the server determines that a campaign is achieving a CTR goal but underperforming on engagement threshold, the server may can allocate more budget towards high-engagement impressions. As another example, the server continuously reallocates budget and bids in real-time, such that server optimizes performance across each campaign goal by adjusting spending dynamically based on performance data.

FIG. 3 shows operations of a method 300 for computer-implemented bid processing by optimizing on dual-variables in bid pricing for multiple placement goals. The method 300 employs, for example, non-linear programming and mixed integer programming to optimize bid prices for individual bid requests according to the multiple placement goals, rather than considering or optimizing for a single placement goal across groups of bid requests. In this way, the method 300 allows the server to flexibly achieve or closely satisfy the multiple goals specified by the user. For ease of description and understanding of the dual-variable optimization method 300 of FIG. 3, certain operations of the multi-goal configuration method 200 of FIG. 2 are not repeated here, though embodiments may include or implement operations described in either of the methods 200, 300.

Bid prices are computed based on historical data, KPI predictions, and the user's preconfigured placement goal objectives using a bid-to-win probability function. The server solves an optimization problem that balances a probability of winning against the preconfigured campaign goals. The server may determine and leverage dual variables for computational efficiency during a RTB process for a new bid request. The bid prices are dynamically calculated and mapped to real-time bid requests as are received, such that the server can bid optimally on each incoming opportunity for a given online resource.

For ease of description, a server computer (e.g., placement server 105) performs various operations described for the method 300, though embodiments are not so limited. In other embodiments, the method 300 or certain aspects of the method 300 may be performed by any number of computing devices and/or by various types of computing devices. In some embodiments, for example, the method 300 may be performed by one or more components described with respect to the system 100 of FIG. 1.

In operation 301, the server obtains one or more configuration inputs from a content-creator user (e.g., a set multiple goals, assign a priority order to goals in the user interface). For instance, the server obtains one or more configuration inputs indicating a total budget amount, one or more placement goal objectives, and one or more priority values corresponding to the one or more goal objectives, among others.

The configuration inputs may further indicate targeting criteria for the user's content campaign. The targeting criteria for online placement resources, such as domains, websites, SSPs, or impressions, among others.

In operation 303, the server obtains samples of incoming bid requests that match campaign targeting criteria. In operation 305, the server obtains goal performance metrics for each sample bid request. In some cases, the server uses certain machine learning models or machine-learning techniques for determining the goal performance metrics.

The server may collect from a database, bid-stream, or other data source, the historical data from past campaigns, including bid requests and impressions. For each sampled bid request that matches the user's targeting criteria (e.g., geography, audience), the server records or stores certain types of data into a database. These types of sample campaign data include, for example, bid floor, sample weight, and performance metrics or scores for objective goals. The bid floor includes a minimum price that may be bid, if any. A sample weight includes a representation (e.g., one or more weight values, feature vector, array) of certain sample data values in the overall population. The performance metrics scores (e.g., KPI metrics or scores) may include observed or predicted objective goal scores, such as an expected CTR, an indicator of whether the sample data involved a bid request for a premium domain, and a probability of engagement or conversion. These KPI scores help the server understand a potential value of each sample bid request and future bid requests.

In operation 307, the server generates optimal bid prices for one or more bid requests. For instance, for each sample, the server generates a set of goal performance metrics for the plurality of placement goal objectives based upon the historical campaign data of the prior content placement. The server may generate the optimal bid prices based upon a non-linear optimization function. The server, for example, formulates a non-linear optimization problem that incorporates the placement goals as constraints or parameters or as an objective function executed by the server. In some implementations, the server discretizes the non-linear optimization problem into a mixed integer program.

The server's bid-computation process involves mapping sample bid prices to the expected win probability for each bid request. The server references the historic campaign data to derive the mapping. For instance, the server derives or generates the mapping from historical win or loss data. The server can generate or model the mappings using machine learning techniques. The machine-learning models may include support vector machines, neural networks, gradient-boosted trees (CatBoost or XGBoost), or statistical models, such as non-linear mixtures of gamma distributions. Using this bid-to-win probability function, the server outputs an estimate of a probability of winning a bid at various price points for each particular sample bid request (or inbound bid request). For instance, if the server bids a first amount (e.g., $1), the server determines a first probability of winning (e.g., 30%), and that bidding a second amount (e.g., $2) produces a second probability of winning (e.g., 50%, 70%).

After the server establishes the bid-to-win probability function, the server formulates the non-linear optimization problem. The server integrates the user's campaign objective goals or threshold goal values (e.g., maximizing an amount of impressions; minimizing cost-per-click (CPC); achieving a preconfigured engagement rate) either as part of the objective function (what the system is trying to maximize) or as constraints (threshold values). The server executes or solves this optimization framework to compute the optimal bid prices for each sampled bid request, thereby balancing the probability of winning against the user's campaign objective goals.

In operation 309, for each sample, the server obtains dual variables associated with the constraints or objective function using the optimization function. The server obtains the dual variables based upon solving the optimization function, which may include solving as the mixed integer program using the placement goal objectives or other types of input values.

Given the complexity of the server computing the bid prices for potentially millions of bid requests, the server reduces the computational load by calculating dual variables. These dual variables simplify the operations, representing the constraints in the optimization problem with comparatively fewer variables than directly specifying bid prices for each request. This reduces the computational overhead and communication between the software components of the server and allows for faster decision-making.

In operation 311, the server generates an optimal bid price for an incoming bid request indicating an online resource using the dual variables of the optimization function. For instance, the server generates the optimal bid price for each incoming bid request for the online resource of the bid request using the dual variables and estimated performance metrics.

As an example, in a real-time bidding scenario, when the server receives a new bid request, the server need not compute everything from scratch. Rather, the server uses the dual variables and the real-time KPIs for the incoming bid request to dynamically calculate the optimal bid price for the online resource indicated in the bid request. The server determines and evaluates the real-time goal predictions, such as expected CTR or likelihood of engagement, and applies the dual variables to determine the optimal bid price in real time. The server may, for example, execute the mapping function to map bid prices to the real-time bid request.

The server may generate a bid placement instruction for placing campaign content (sometimes referred to as content objects that are to be displayed on a display device such as an end-user device as described herein) for at least one online resource that satisfies the optimal bid price for the online resource and other goal thresholds for the online resource. The server submits the computed bid price into the bid-stream for auction, competing against other advertisers for the same impression. If the server wins the auction based on the computed bid price, then the server proceeds to serve or forward the content. If the server loses the auction, then the server does not provide the content for placement and the system moves on to evaluate the next available bid request.

Referring now to FIGS. 4A and 4B, the configurator user interface 400a and a configurator user interface 400b. As shown, with reference to FIG. 4A, a user can interact with a “Goals” tab of the configurator user interface 400a to configure and prioritize multiple goal objectives for a campaign. The user may, for example, configure or add one or more goals and indicate priorities for each goal, update or introduce new goals or priorities, among other configuration operations. In some cases, the user may configure multiple goals or indicate priorities of the goals according to the types of goals (e.g., conversion, engagement). For example, the user can provide input to select, or deselect, the priority checkbox 402 The priority checkbox 402 can allow the user to indicate to a placement server (e.g., that is the same as, or similar to, the placement server 105 of FIG. 1) to enforce a strict ordering of priorities and cause the placement server to confirm that the first goal is met before optimizing any subsequent goals. In this example, the first priority field 404 contains a “Scale (Budget Delivery)” goal, which is set as the default for all campaigns. The user can leave this default or change it. The second priority field 406 can be configured with “eCPM (ML Price Optimization)” as a default for enterprise clients. The user can also indicate the desired budget allocation or cost efficiency by entering a numeric threshold into the associated target value field 408. The third priority field 410 shows “Viewability” as another goal, which may also be paired with a third priority field 412 for setting a target percentage of impressions viewed. To add more goals, the user can selects the “+Add Goal” button, and can then drag and drop goals to reorder their corresponding priorities, creating a tailored optimization hierarchy for the campaign.

In FIG. 4B, the configurator user interface 400b shows on how a user can select and modify goal types within priority slots. In this example, for the second priority field 406, the goal dropdown has been activated, showing a list of priority field options 414 such as CTR, Page Start Rate, Cost Per Page Start, CPC, Engagement Rate, Viewability, and Conversion. The user can select a desired metric type, for example, “CTR,” and then enters a numeric performance target into the corresponding target value field 408 (e.g., 0.2 for a targeted click-through rate). The third priority field 410 (e.g., “CPC,”) can include a target value field 412 to indicate an acceptable cost-per-click threshold, such as $1.30. As the user continues to add goals, priorities like “eCPM (ML Price Optimization)” and “Unique Reach” can be inserted into priority slots further down the list, each paired with a desired target value. By mixing and ordering the goals in this way, and by defining explicit thresholds, the user can establish a multi-objective optimization strategy that the placement server can follow during the campaign's real-time bidding and placement processes.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc., are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

Some non-limiting embodiments of the present disclosure are described herein in connection with a threshold. As described herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open ended terms. Further, the phrase “based on” is intended to mean “based at least partially on” unless explicitly stated otherwise.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for multi-objective evaluation for computer-implemented data transmission within a distributed network environment, the method comprising:
obtaining, by a computer, one or more configuration inputs indicating a total amount, a plurality of placement goal objectives, and one or more priority values corresponding to the one or more placement goal objectives;
obtaining, by the computer, historical targeting configuration data for a plurality of prior data transmissions;
for each prior data transmission, generating, by the computer, a set of goal performance metrics for the placement goal objectives based upon the historical targeting configuration data of the prior data transmission;
generating, by the computer, a blocklist comprising a set of one or more online resources having a goal objective value of a corresponding goal objective that fails to satisfy a threshold for the goal objective; and
generating, by the computer, a placement instruction for placing content objects for at least one online resource in accordance with the blocklist.

2. The method of claim 1, further comprising receiving, by the computer, user input specifying a minimum acceptable performance threshold for each placement goal objective.

3. The method of claim 1, wherein generating the blocklist includes analyzing, by the computer, historical performance data for each online resource to identify online resources that repeatedly fail to satisfy the threshold for at least one placement goal objective.

4. The method of claim 1, further comprising blocking, by the computer, at least one placement instruction for at least one content object associated with at least one online resource included in the blocklist.

5. The method of claim 1, wherein generating the placement instruction comprises excluding, by the computer, any online resource included in the blocklist from eligibility for receiving content objects.

6. The method of claim 1, further comprising updating, by the computer, the blocklist in response to real-time performance data received during execution of the targeted placement.

7. The method of claim 1, wherein the set of goal performance metrics includes at least one of a cost-per-click, a click-through rate, an engagement rate, or a conversion rate.

8. The method of claim 1, further comprising providing, by the computer, a user interface including the blocklist for display at a user device, the user interface configured to obtain an instruction for inclusion of an online resource in the blocklist.

9. The method of claim 1, wherein obtaining the historical targeting configuration data includes retrieving, by the computer, placement-level data for each prior data transmission from one or more databases.

10. The method of claim 1, further comprising transmitting, by the computer, the placement instruction to a placement engine configured to execute real-time targeting for data transmission.

11. A method for computer-implemented data transmission by optimizing on dual-variables in data transmission, the method comprising:
obtaining, by a computer, one or more configuration inputs indicating a total value amount, one or more placement goal objectives, and one or more priority values corresponding to the one or more goal objectives;
obtaining, by the computer, a plurality of samples of a plurality of sample target requests based upon a set of placement target criteria, each sample including target request data of a sample target request for a sample online resource satisfying the target criteria;
for each sample, generating, by the computer, a set of goal performance metrics for the plurality of placement goal objectives based upon historical targeting configuration data of prior content placement;
for each sample, obtaining, by the computer, dual variables for an optimization function based upon the goal performance metrics corresponding to an optimal sample value for the sample online resource corresponding to the sample; and
generating, by the computer, an optimal target value for an incoming target request indicating an online resource using the dual variables of the optimization function.

12. The method of claim 11, further comprising storing, by the computer, the dual variables in a non-transitory memory accessible to a placement engine for determining a next target value.

13. The method of claim 11, wherein obtaining the plurality of samples comprises retrieving, by the computer, target request data from a real-time stream associated with a plurality of online resources.

14. The method of claim 11, further comprising updating, by the computer, the set of dual variables in response to one or more updates to one or more performance metrics received during execution of the targeted placement.

15. The method of claim 11, wherein the set of goal performance metrics includes at least one of an expected click-through rate, an expected engagement rate, an expected conversion rate, or an expected cost-per-click.

16. The method of claim 11, further comprising transmitting, by the computer, the optimal target value to a placement engine configured to submit the target request for the incoming target request.

17. The method of claim 11, wherein the optimization function includes a non-linear programming model configured to optimize on the plurality of placement goal objectives according to the priority values.

18. The method of claim 11, further comprising generating, by the computer, a report indicating the optimal target values and corresponding dual variables for a plurality of online resources.

19. The method of claim 11, wherein obtaining the dual variables includes executing, by the computer, one or more machine-learning models, including at least one of a gradient-boosted tree, a support vector machine, or a neural network.

20. The method of claim 11, further comprising providing, by the computer, a user interface including the optimal target value for display at a user device, the user interface configured to obtain an adjustment input to at least one priority value for the placement goal objectives.
